(19) United States
(12) Patent Application Publication
(10) Pub. No.: US 2017/0109453 A1
(43) Pub. Date: Apr. 20, 2017

(54) SYSTEM AND METHOD FOR COLLECTING CONSUMER DATA

(71) Applicant: LUTH RESEARCH, LLC, San Diego, CA (US)

(72) Inventors: Roseanne LUTH, Rancho Santa Fe, CA (US); Baixue WU, San Diego, CA (US); Anthony F. IASI, San Diego, CA (US); Benjamin M. WALKER, San Diego, CA (US)

(21) Appl. No.: 15/394,664

(22) Filed: Dec. 29, 2016

Related U.S. Application Data
(63) Continuation of application No. 12/818,603, filed on Jun. 18, 2010, now abandoned.
(60) Provisional application No. 61/269,218, filed on Jun. 22, 2009.

(51) Int. Cl. G06F 17/30

(52) U.S. Cl. CPC G06F 17/30873; G06F 17/30876; G06F 17/30371; G06F 17/30598; G06F 3/04817

(57) ABSTRACT

A system and method for collecting consumer browsing on-line behavior and survey data comprising a browser toolbar application located within a consumer's computing device, and interactively graphically displayed on said computing device, for collecting and recording consumer browsing activity information and a communication service for transmitting said consumer browsing activity information to a server, wherein said server performs aggregation and analysis on said browsing activity information and a multi-platform communication application to render browsing activity information relevant content to consumers based on said toolbar application collected and recorded browsing activity and said performed aggregation and analysis.

### CROSS-REFERENCE TO RELATED APPLICATIONS

This application is a continuation of U.S. application Ser. No. 12/818,603, filed Jun. 18, 2010, which is based on and claims priority to U.S. Provisional Application No. 61/269,218, filed Jun. 22, 2009, the entire contents of each of which is fully incorporated herein by reference.

### FIELD OF THE INVENTION

This invention generally relates to systems and methods for collecting consumer browsing data from computers, wireless devices, telephones and televisions, and more particularly to systems and methods for collecting consumer browsing data and transmitting that data and related information to a server to perform aggregation and analysis and provide communication across multiple platforms and using multiple methodologies.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

A better understanding of the features and advantages of the present invention will be obtained by reference to the following detailed description that sets forth illustrative embodiments, in which the principles of the invention are utilized, and the accompanying drawings of which:

FIG. 1 illustrates a typical Internet/Client/Server system, in accordance with the present invention.

FIG. 2 schematically shows a client device, in accordance with the present invention.

FIG. 3 schematically shows a Client Configuration File, in accordance with the present invention.

FIG. 4 shows an exemplary graphical user interface that displays the contents of the Luthincentives directory, in accordance with the present invention.

FIG. 5 schematically shows an XML File, in accordance with the present invention.

FIG. 6 schematically shows a server that is used in accordance with the present invention.

FIG. 7 illustrates the operations of the various components of a client device, in accordance with the present invention.

FIG. 8 is a representation of a toolbar in a browser, in accordance with the present invention.

FIG. 9 is a flowchart that illustrates the collection and recording of consumer data using a toolbar, in accordance with the present invention.

FIG. 10 shows a flowchart illustrating the steps performed by a communications service to transmit recorded consumer data to a server, in accordance with the present invention.

FIGS. 11-18 are exemplary screenshots of a graphical user interface used in conjunction with an AIR application, in accordance with the present invention.

FIG. 19 is a flowchart illustrating the steps performed by a server to extract recorded consumer data in accordance with an embodiment of the invention, in accordance with the present invention.

FIG. 20 is a flowchart illustrating the analysis steps performed by a server, in accordance with the present invention.

### DETAILED DESCRIPTION OF THE INVENTION

Referring to the drawing figures, like reference numerals designate identical or corresponding elements throughout the several figures.

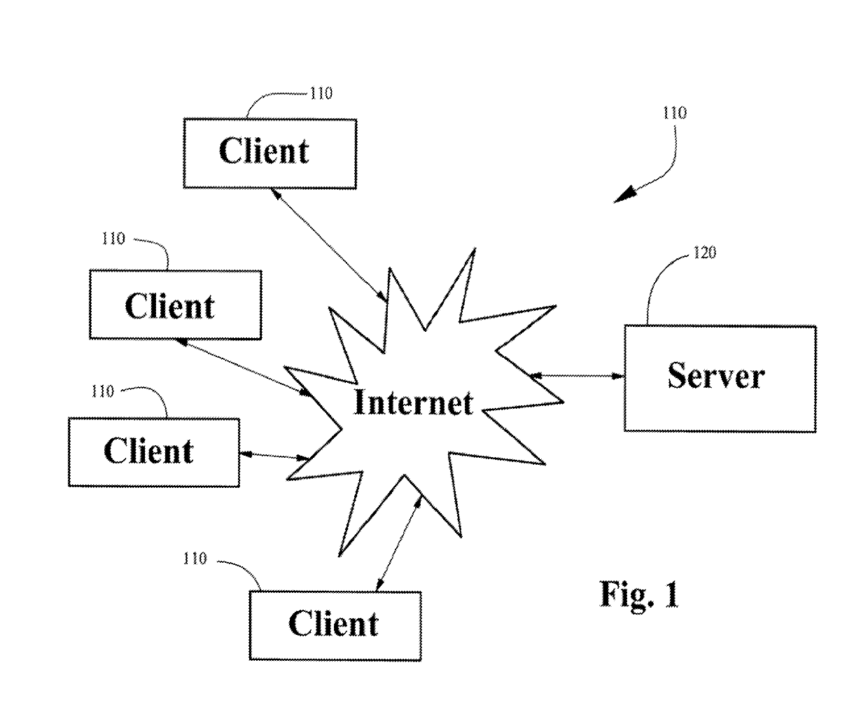

FIG. 1 illustrates a System 100 in accordance with the present invention. System 100 comprises a plurality of client devices 110 connected to the Internet. The client devices 110 detect and collect information regarding a user's browsing activity and transmit this information to server 120 via the Internet. The client device 110 is any device capable of communication over the Internet via a browser including, but not limited to, general purpose computers, Internet ready telephones and other wireless communication devices, Internet enabled TVs and auxiliary devices, etc. Server 120 is a computer located at a central site for receiving and processing the information gathered by client devices 110. The client device 110 includes data input elements such as a keyboard or pointing devices. The client further includes appropriate communications hardware and volatile and non-volatile memory elements in or on which are stored an operating system and application software which allow a user to send and receive data. Such software includes application software commonly referred to as a browser such as Internet Explorer, Firefox, Safari, Chrome and the like.

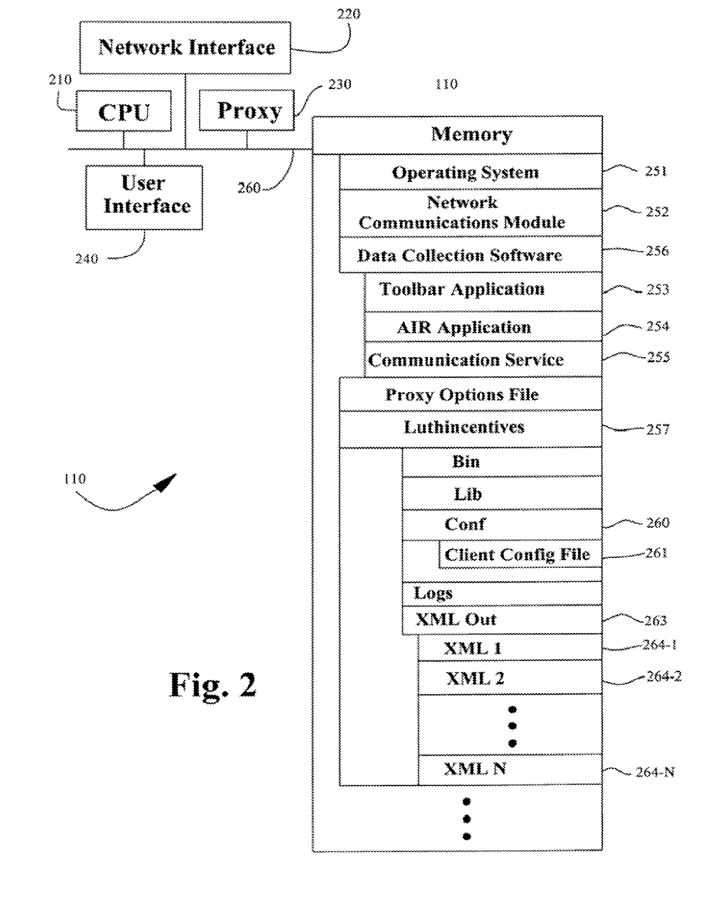

FIG. 2 schematically illustrates a client device 110 in accordance with the present invention. The client device 110 includes one or more central processing units (CPU's) 210, at least one network or other communications interface 220, a local proxy 230, a memory device 250, and one or more communication buses 260 for interconnecting these components. The memory 250 may include high speed random access memory and may also include non-volatile memory, such as one or more magnetic disk storage devices.

The memory 250 preferably stores an operating system 251 that includes procedures for handling various basic system services and for performing hardware dependent tasks; a network communication module 252 that is used for controlling the communication between the client device 110 via the network interface(s) 220 and one or more communication networks, such as the Internet, other wide area networks, local area networks, metropolitan area networks, and so on; a toolbar module 253, an Adobe Integrated Runtime (hereinafter abbreviated AIR) application 254; and a communication service 255. The toolbar module 253, the AIR application 254 and the communication service 255 are herein collectively referred to as the data collection software, 256.

Memory 250 also comprises a Luthincentives directory 257 that stores information for use in conjunction with AIR application 254, communication service 255 and toolbar application 253. The directory 257 also includes a “Conf” folder 260 that includes a Client Config File 261. The Luthincentives directory 257 also comprises an “XML Out” directory 263 that stores XML files 264 that are recorded by the toolbar application 253.

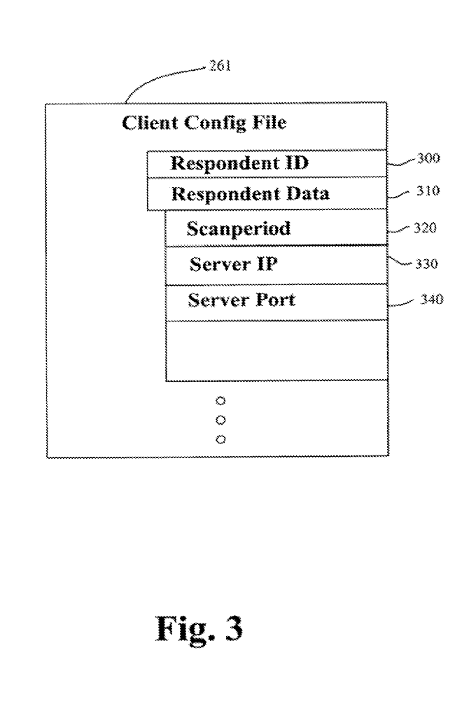

FIG. 3 schematically shows an exemplary Client Config File that may be used in accordance with the invention. File 261 is created and managed by the AIR application 254. The AIR application 254 provides user identifying information and other relevant information that may be necessary for collecting browsing activity to Client Config File 261. The Client Config File 261 stores information used by the toolbar application 253. Client Config File 261 stores a Respondent ID 300, Respondent Data 310, Scanperiod 320, Server IP 330 and Server Port 340, and any other required files. The respondent ID 300 uniquely identifies each user for whom browsing activity data is collected and is used both by the toolbar 253 and the AIR application 254 to identify account information and also to tag the XML files generated by the toolbar 253. Respondent data field 310 contains other relevant data about the user that may be used for collecting browsing activity. The Scanperiod 320 is a predetermined time interval that is used by the communication service 255 when transmitting the XML files 264 to server 120. The Scanperiod 320 is provided to the Client Config File 261 during installation of the data collection software. Optionally, Scanperiod 320 may be provided to file 261 by server 120 after installation of the data collection software. Additionally, the Scanperiod 320 may be modified after installation by server 120.

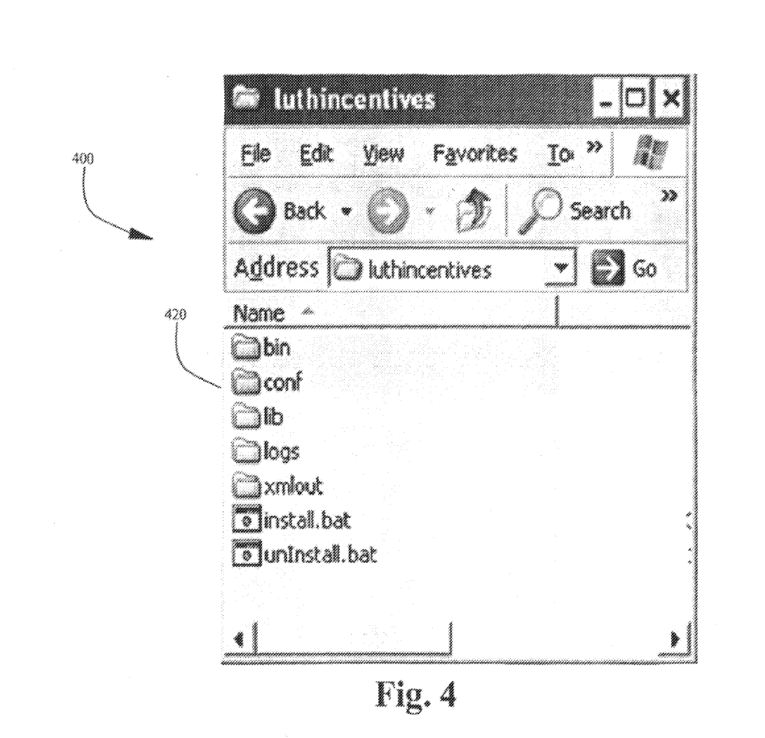

FIG. 4 shows an exemplary graphical user interface 400 that displays the contents of the Luthincentives directory 420 which contains the relevant information used by data collection software, 256. The Luthincentives directory contains five directories, bin, conf, lib, logs, and xmlout. The bin directory contains the compiled code and executables, the conf directory contains the configuration files, the lib directory contains additional code libraries, the logs directory contains system and error logs, and the xmlout directory stores the XML files prior to transmission to the server. The desktopconfig.txt file located within the conf directory contains the data which provides the settings for the application to function. These configuration settings include the port and IP address of the server, device identifier, respondent identifier, debugging settings, and other information.

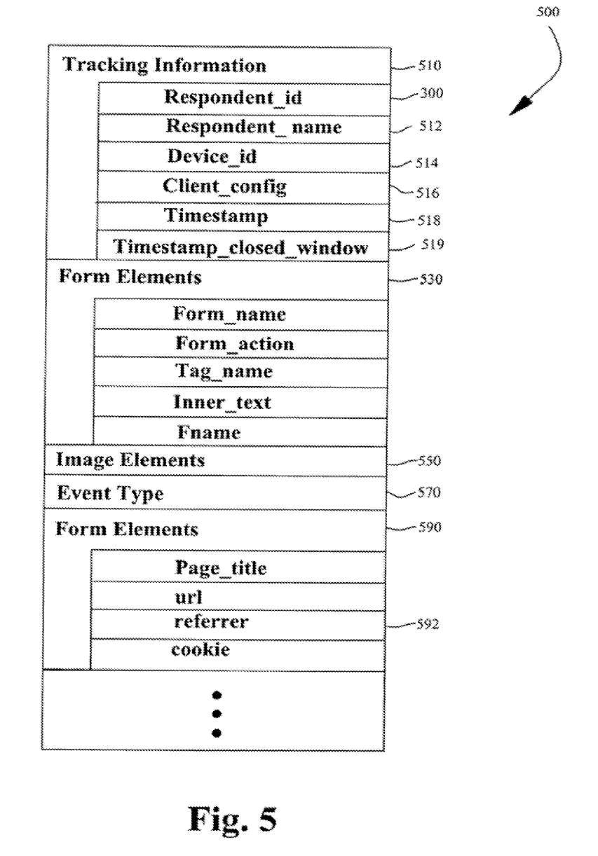

FIG. 5 schematically illustrates an exemplary XML file 500 recorded by toolbar application 253. The XML file contains a series of specific activity tags as well as the Respondent Identification. File 500 comprises tracking information 510, form elements 530, image elements 550, event type 570 and page elements 590. Other information relevant to conduct consumer behavior analysis may also be collected and stored in the XML file 500. Tracking information 510 includes various tags including Respondent ID 300, Respondent name 512, Device ID 514, Client Config 516, timestamp 518 and timestamp_closed_window 519.

The Device ID 514 is used to identify respondents who may have multiple installations of the AIR application across a variety of computing devices. Each computing device, PC, Macintosh, cell phone or PDA has a unique identifier. Typically, this is the device's MAC address embedded in the internet communications card. Thus, a respondent with the same respondent identification may use a PC one day, a Macintosh another day, a PDA the next day. The server can then associate the activity at each of these computers with the same user.

The Client_Config tag 516 is the pathname to the directory on the client device 110 where the data collection software is installed and more particularly where the Client Config File 261 is located. This tag is primarily used for diagnosis of potential problems during the installation of the data collection software or for troubleshooting the application post-installation. The Timestamp 518 and Timestamp_closed-window 519 contain the date and time when a page is viewed and when a page is exited, respectively.

Form Elements 530 records information regarding forms that are used on a webpage. Forms are a general mechanism used on a webpage to communicate data back to the website's server. It can contain a variety of fields, drop-down selectors, text entry fields, check boxes, radio button selectors, etc. Any information entered by the user on the webpage form is recorded in the XML file. In one embodiment, the Form Element 530 is a root or a parent tag that groups a subset of other tags that identify specific components of the form itself. These sub-tags, for example include, but are not limited to form_name, form_action, tag_name, innertext and fname. Image Elements 550 record the pathname of the URL of the image. Page Elements 590 contains the page title, URL and cookie contents for the webpage. Page elements 590 also include a Referrer 592 which contains the URL of the previous page linking to the current page.

Event Type 570 classifies the webpage based on the page title. The event types include, but are not limited to, “Purchase”, “Registration”, “Search”, “Review”, and “Blog Submission.” Where an event type is not one of the categories identified above, it will be classified as “General”. In one embodiment, the toolbar 253 determines the event type based on the title of the web page. Thus, for example, if the page title is “Thank you for ordering.” The toolbar 253 is able to detect that this is a purchase. Moreover, because the page title itself is being sent to the server 120, the server is able to determine that this is a purchase.

In other embodiments, the toolbar uses predetermined criteria to determine the event type of the particular page the user is visiting. This predetermined criteria could be based on other behaviors detected from the user and may include the information provided to the toolbar 253 in the Respondent Data 310 stored in Configuration File 261. In yet another embodiment, the AIR application 254 may query the user to determine the event type. In yet another embodiment, the AIR application detects certain behaviors noted in the XML files 500 produced by the toolbar 253 and then verifies the event type using a poll conducted by the AIR application 254. The use of the query function and also the polling function provides significantly more accurate data because the event type is not inferred from the web page but is identified and confirmed directly by the user.

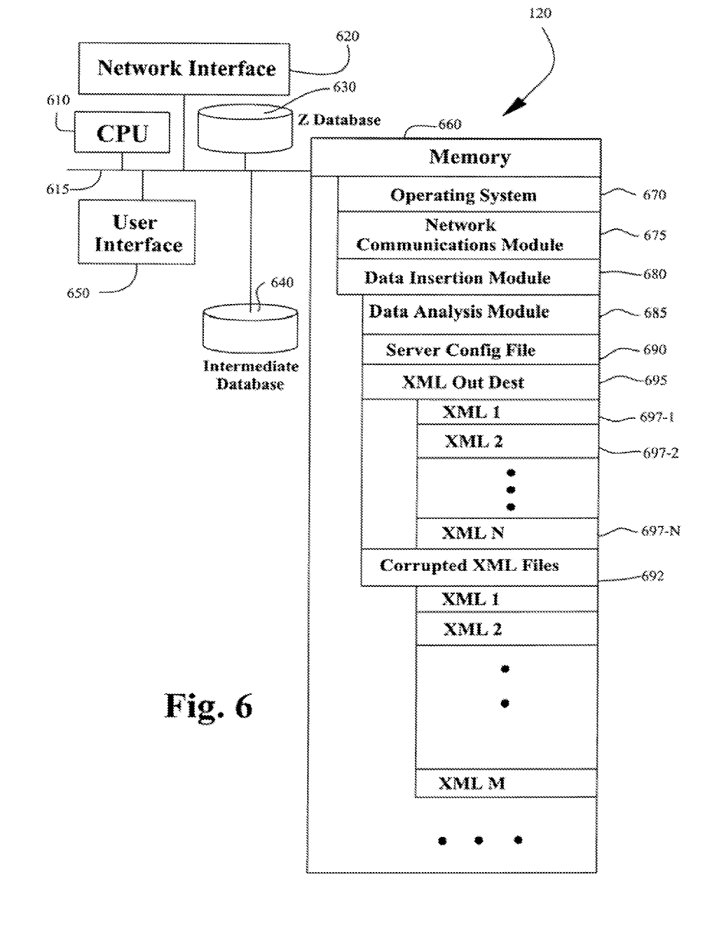

FIG. 6 schematically illustrates a server 120 in accordance with the present invention. The server 120 includes one or more central processing units (CPU's) 610, at least one network or other communications interface 620, a user interface 650, a Z database 630, an Intermediate Database 640, a memory device 660, and one or more communication buses 615 for interconnecting these components. A “Z database” is defined as a database or data warehouse which stores the browsing data and derived information after analysis. The user interface 650 is may be used by an administrator to perform certain aspects of the present invention such as sending communications to the AIR application. The memory 660 may include high speed random access memory and may also include non-volatile memory, such as one or more magnetic disk storage devices.

The memory 660 preferably stores an operating system 670 that includes procedures for handling various basic system services and for performing hardware dependent tasks; a network communication module 675 that is used for controlling the communication between the server 120 via the network interface(s) 620 and one or more communication networks, such as the Internet, other wide area networks, local area networks, metropolitan area networks, and so on; a data insertion module 680 that is used to extract data from the XML files stored in the Intermediate Database 640, a data analysis module 685 that is used to perform analysis on the data extracted by the data insertion module 680. Memory 660 further includes a Server Config File 690 that stores information used by the Data Insertion Module 680 and Data Analysis Module 685. Memory 660 also includes a directory “XML Out Dest” 695 that stores the XML files received by server 120 from the communication service 255. Memory 660 additionally includes a Corrupted XML Files directory for storing the received XML files that contain errors after the parsing and writing steps performed by the Data Insertion Module 680.

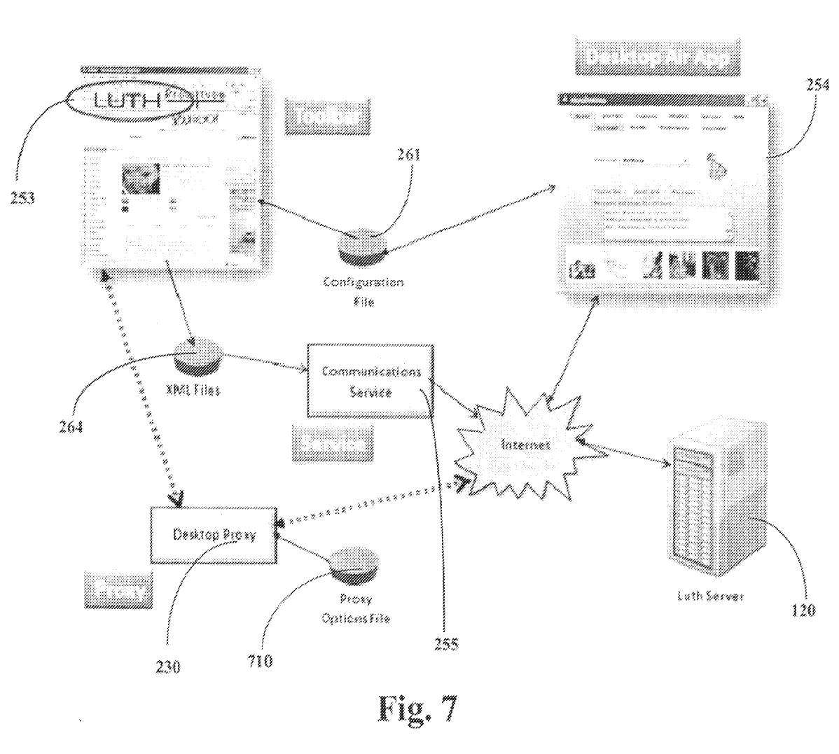

FIG. 7 illustrates how the various components described above are used in accordance with an embodiment of the invention. The AIR application 254 provides, inter alia, user identification and data to configuration file 261. The toolbar 253 uses this information to collect data during a browsing session and further to include identifying information in the XML file 264 that records the user's browsing activity. The communication service 255 then transmits the XML files 264 to server 120 via the Internet. In addition to using the toolbar 253, a local proxy 230 is also used to detect and gather respondent activity information. The local proxy 230 performs these functions in accordance with and in conjunction with the local proxy options file 710.

### Toolbar Application

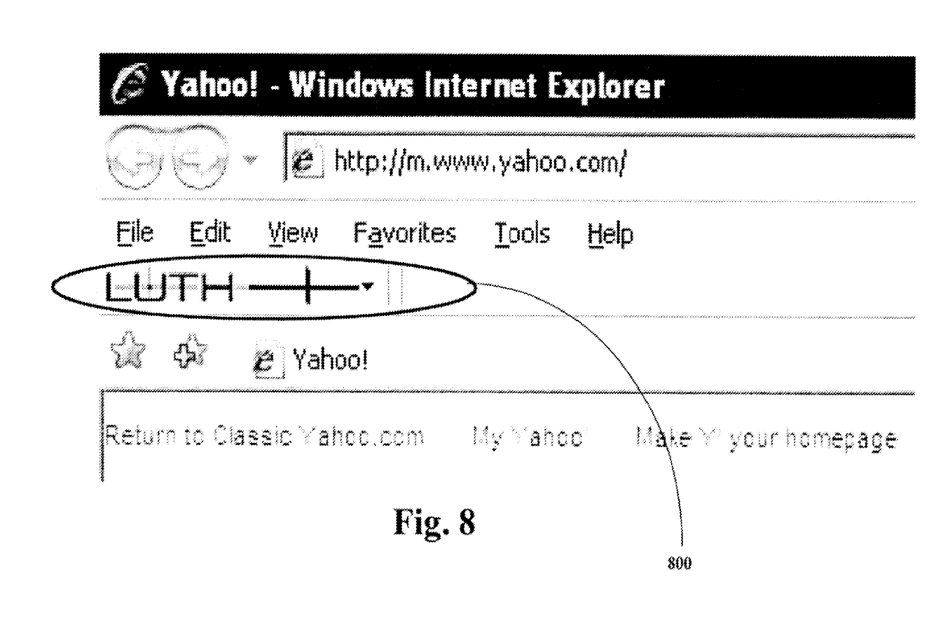

FIG. 8 shows an exemplary web browser toolbar in accordance with an embodiment of the invention. The toolbar 253 is a standard toolbar plug-in that has been modified for use with the present invention. It is installed by the user and appears as a visible toolbar icon 800 on a browser. In one embodiment, the user has the option to turn off the data detection and collection activity by, for example, clicking on the icon 800. Other browser extensions or add-ons designed for installation into a web server may also be used to detect and collect browsing activity. The toolbar 253 provides a comprehensive approach to recording user activity available during a typical session of internet browsing.

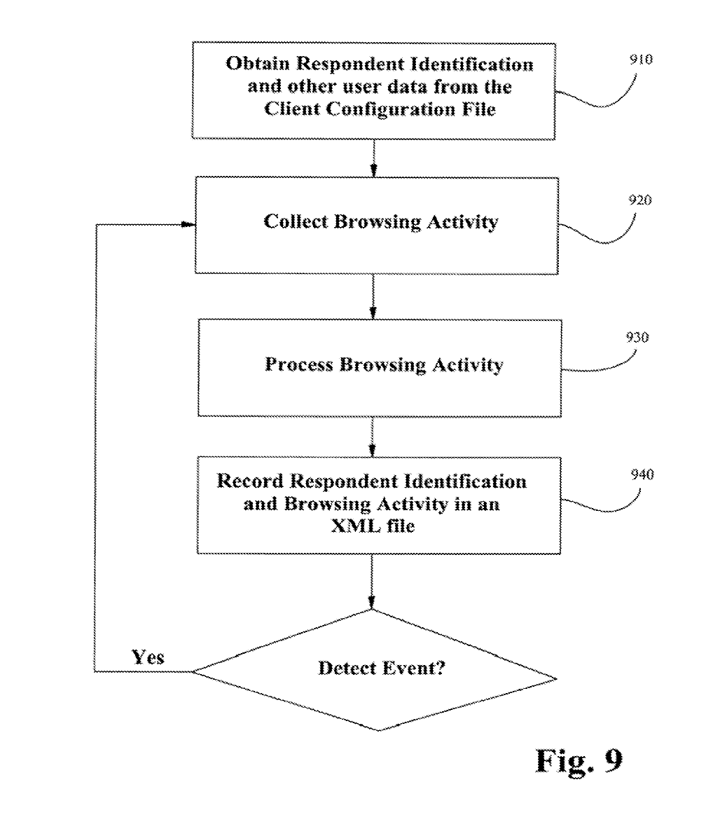

FIG. 9 shows the steps used to collect and record browsing activity using the toolbar 253. In step 910, the toolbar 253 obtains the respondent identification 300 and respondent data 310 from Client Config File 261. The respondent identification 300 stored in the Client Config File is the identification of the last user that used the browser. Thus, where multiple users are associated with one AIR application 254, only the respondent identification and respondent data for the last user is stored in the Client Config File. In step 920, the toolbar collects information regarding the user's browsing activity. The type of information the toolbar 253 collects and records includes, but is not limited to, the type of visit, the web page title, the time the webpage was visited, the webpage URL, the URL of a referring webpage, contents of any cookies associated with the webpage, list of any images found on the webpage, the contents of any forms found on the webpage.

In step 930, the toolbar 253 performs predetermined processes on the collected data before recording (step 940) the respondent identification and the browsing activity data in an XML file 264 for later handling by communication service 255. The data is written to the user's hard drive and stored in memory 250 for later handling by the communication service 255. This data is recorded and stored using a standardized file format such as XML. Other file formats such as binary, compressed, HTML or objective data, are also contemplated by the invention. The toolbar 253 performs steps 920, 930, 940 whenever it detects an event. An event herein comprises a user-initiated action such as clicking on a link, image, tab, or any number of interface controls.

### Communications Service Application

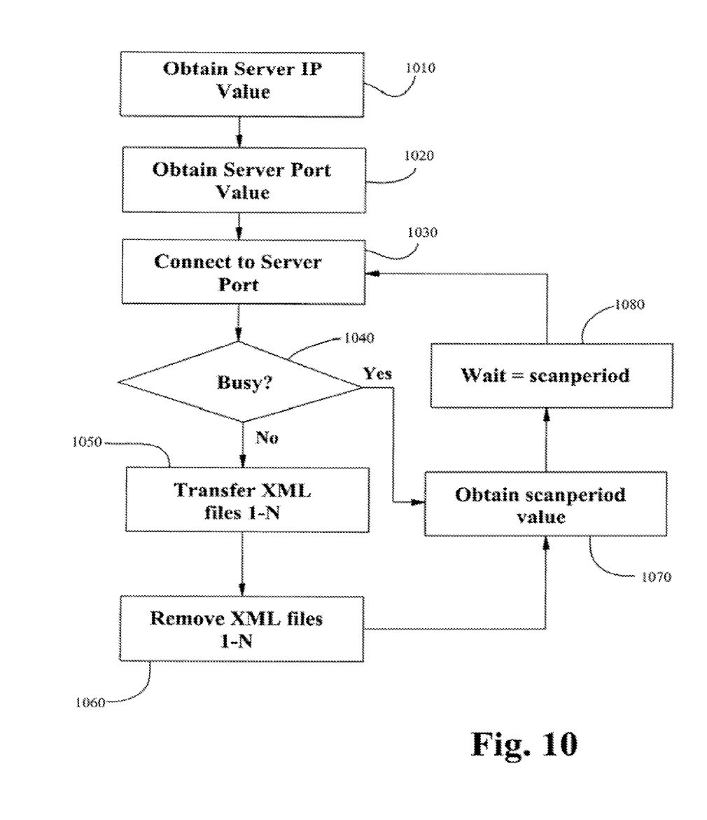

FIG. 10 illustrates the steps used to transmit the recorded browsing activity data in accordance with the invention. Communication service 255 runs in the background and makes periodic connections to the server 120 in order to transfer the XML files 264 created by toolbar 253 over to the server 120 for further analysis and processing. In one embodiment, the service 255 is implemented in Java using standard socket technology. In steps 1010 and 1020, the communications service 255 obtains the values for the server IP and server port from Client Config File 261 and connects to the server 120 via the Internet (step 1030). Prior to transmitting the XML files, the service 255 determines whether the server 120 is busy (step 1040).

If, in step 1040, the server is busy then the service obtains the value for scanperiod from the Client Config File 261 (step 1070). Scanperiod is the time interval between connections to the server 120. In one embodiment, the scanperiod is equal to 10,000 milliseconds. The service then waits for the duration of the scanperiod in step 1080 and connects to the server again (step 1030).

If, in step 1040, the server is not busy then the service transfers the XML files 264 to the server 120 in step 1050. The service then removes the XML files 264 from the XML Out directory 263 in step 1060 and performs steps 1070 and 1080 as described above and connects to the server again (step 1030).

In other embodiments, the service 255 transmits data to the server 120 during intervals that meet predetermined criteria. These predetermined criteria, for example, may include determining when there is low internet activity and transmitting the data during this time. These criteria may also include other activity such a user log off with the data being transmitted as part of the log off process. In other embodiments, the transmission may occur when the computer system is shutting down.

Use of the communications service 255 allows a managed distribution of processing activity to minimize resource impact. The service 255 is able to wait sufficient time until the client device resources are available. At an appropriate point, service 255 takes the XML files generated from the toolbar and transfers them to the server 120. Thus, the large amount of data collected during a given internet browsing session is transmitted at times when there is greater available bandwidth and resources, thereby minimizing its impact on the use of the computer. Current toolbar applications are directly connected to the server via the Internet and transmit collected data real time to the remote server. This burdens the user device with an unreasonable demand for bandwidth and resources. Storing data in a temporary location and only transmitting the data when use of the resources would not unreasonably burden the system minimizes the impact of the data collection activity on the user and thereby the user is more likely to continue to participate in the data collection activity.

### AIR Application

An AIR application is defined as an Adobe Integrated Runtime application which when installed on a users computing device provides a platform of communication between the person and the server.

The AIR application employed by the present invention is based on Adobe's Flex language and is packaged as a multi-platform AIR application. Thus it runs as-is on both PCs and Macs. Any user interface program may be used for the AIR application including, but not limited to, AIR, Flash, Java Applets, a browser based interface and any other native or non-native program running on the platform. The AIR application manages the user accounts by allowing users to self-register, select an avatar and set preferences for the various built-in applications such as wish lists, notification options, etc. The AIR application also establishes a communications link between the user and server 120. This can include a variety of embodiments such as simple help-desk function, research functions such as polling and online surveys, inter-member communications such as chat rooms, gaming networks, and other community activity. The AIR application allows a user to control the level of participation, and communicate with other users or the server 120.

Additionally, the AIR application provides incentives for users to continue membership as a respondent and opt-in to activity monitoring. This is achieved by providing an extendible list of features and applications across the various tabs found on the AIR application. For example, discount coupons and YouTube videos tailored to the types of categories most relevant to the particular user. The AIR application provides respondent identification and respondent data information to the Client Config File 261 which is then used by the toolbar 253 to collect and record user browsing activity.

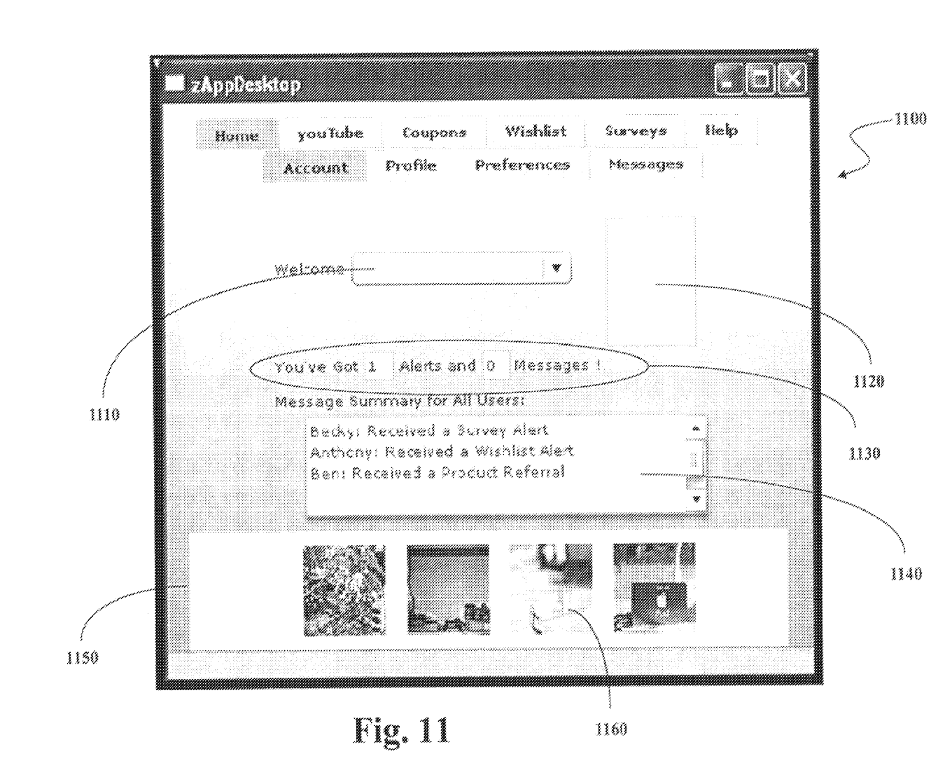

FIG. 11 shows a graphical user interface (GUI) 1100 of the AIR application in accordance with the present invention. GUI 1100 provides a summary of account activity for all users registered with the AIR application. GUI 1100 includes a username field 1110 which contains the name of each user associated with the particular AIR application. Thus, the AIR application provides the ability to collect browsing activity for multiple users on the same device. GUI 1100 also displays an avatar 1120 associated with the user identified in field 1110. A summary of alerts and messages for the user identified in field 1110 is also provided at 1130. In addition, a message summary 1140 shows the messages received from server 120 for each of the users registered with the AIR application. A scroll pane 1150 displaying content 1160 for the user identified in field 1110 is also provided. In one embodiment, content 1160 is selected based on the browsing activity and other parameters associated with the user 1110. Content 1160 can be any information that is relevant to the user 1110. Thus, for example, if the user 1110 is interested in purchasing a car then the content 1160 will contain websites that contain information relevant to purchasing cars. A user can then go to that website by clicking on the icon 1160.

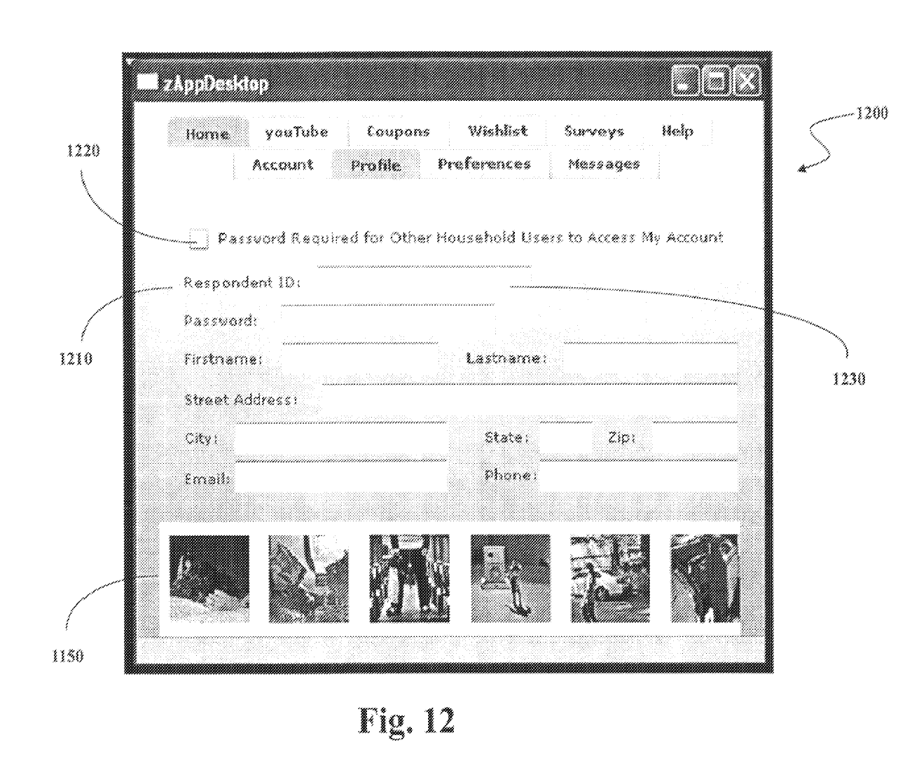

FIG. 12 shows a window 1200 that contains a user's profile information. Window 1200 includes a field 1210 that contains the user's Respondent Identification that is used to collect and track the browsing activity of the user. Scrolling pane 1150 displays content that is relevant to the user identified in field 1210. In one embodiment, the user may choose to restrict access to his or her account by requiring a password by checking box 1220 and providing a password in field 1230. In one embodiment, a user is invited to download the data collection software 256. In this case, the demographic information and Respondent Identification information is already provided and displayed in window 1200.

Where a new user registers using the AIR application 254, a query is made to the server 120 to determine if the user is already in one or more of the existing databases, for example by comparing the name and address provided by the new registrant. If the user is already in one of the pre-existing databases then the respondent identification associated with the user and other demographic information about the user is provided in window 1200. This information is then used by the AIR application 254 and the toolbar 253 for gathering browsing data for that user.

If the user is not already in the database then a new Respondent Identification is generated for the user. This Respondent Identification and the associated identifying information about the user is then transmitted to server 120 where it is stored in the database 630. In addition, the AIR application also stores this information in the Client Config File 261. This Respondent Identification is then used to tag the XML files collected by the toolbar 253 and is also used by the AIR application to provide relevant benefits to the user.

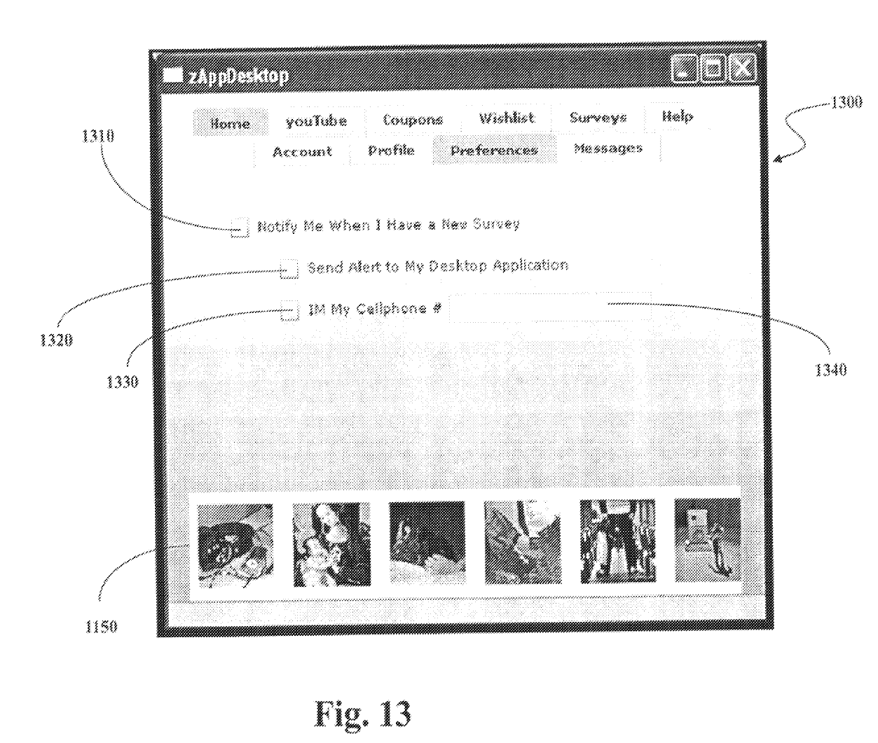

FIG. 13 shows a window 1300 that displays the user's preferences for receiving communications from server 120 in accordance with an embodiment of the invention. In this embodiment, the user may select whether he or she wants to be notified about a new survey by checking box 1310. Additionally, the user may select the method of receiving such notification, for example by receiving alerts through the AIR application by checking box 1320. Alternately, the user can check box 1330 and provide a cell phone number in field 1340 to receive an instant message when a new survey is received. Scrolling pane 1150 continues to display content relevant to the user.

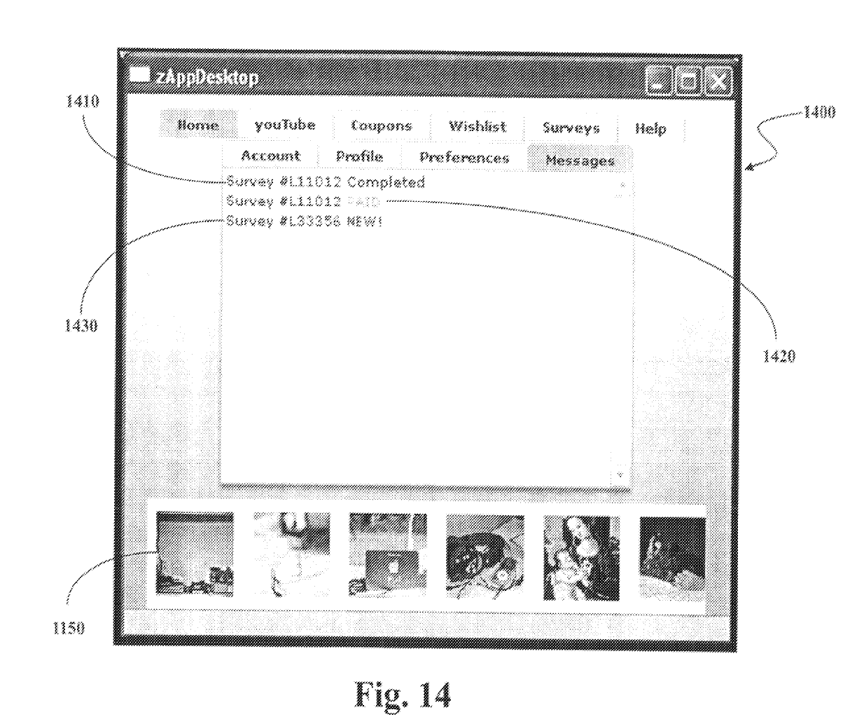

FIG. 14 shows a window 1400 that displays messages received from server 120 in accordance with an embodiment of the invention. For example, the server 120 has notified the user that he has received a new survey #L33356, that he has completed survey #L11012 and that he has been paid for completing this survey. The method of paying users for completing surveys is disclosed in U.S. Pat. Nos. 6,446,044 and 7,194,448, the contents of which are incorporated in their entirety herein by reference. The user may receive other communications from the server 120 as well such as account update information. In one embodiment, the user may receive information regarding a new poll or notification about a new advertisement or the user may be asked to provide feedback regarding a test advertisement. In this case, the user may communicate back to the server with his or her responses. Scrolling pane 1150 continues to provide a stream of content that is relevant to the particular user.

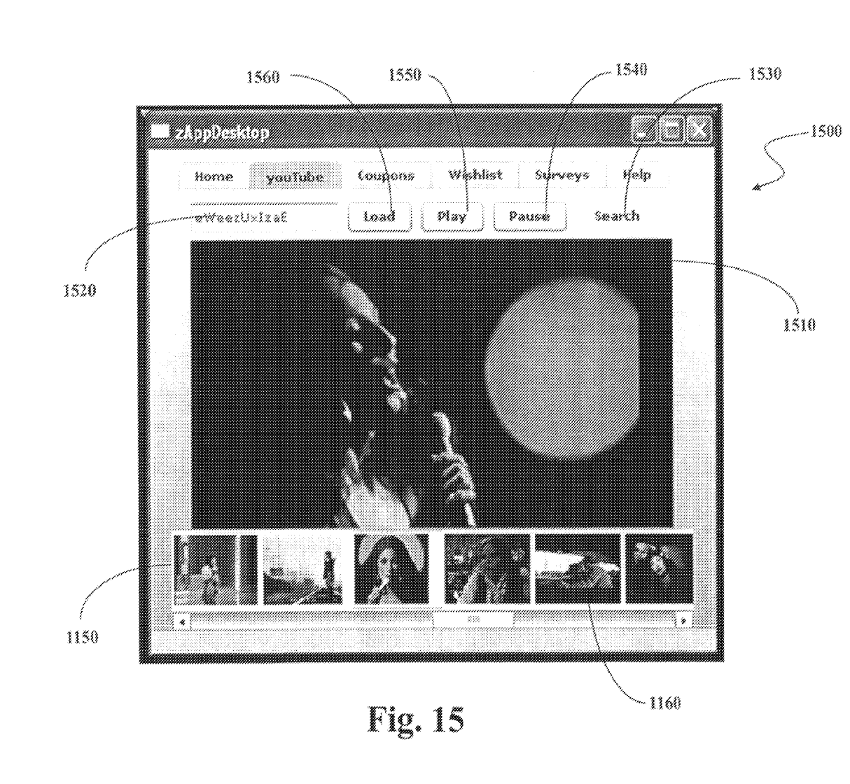

FIG. 15 is a window showing one of the many exemplary benefits provided to the users so that the user will continue to participate in the data collection activities in accordance with the invention. FIG. 15 shows a YouTube application that displays YouTube content 1160 in scrolling pane 1150 based on the user's recent browsing activities. The user may click on any of the icons 1160 to display the content in window 1510. Additionally, the user may search YouTube (or any other video uploading or social networking website) for specific content by entering the search term in field 1520 and clicking on button 1530. The AIR application will then display the search results in the scrolling pane 1150 as icons 1160. The user can then click on icon 1160 to play the content in window 1510. The user can also pause the video by clicking on button 1540, play the video by clicking on button 1550 and load the video by clicking on button 1560.

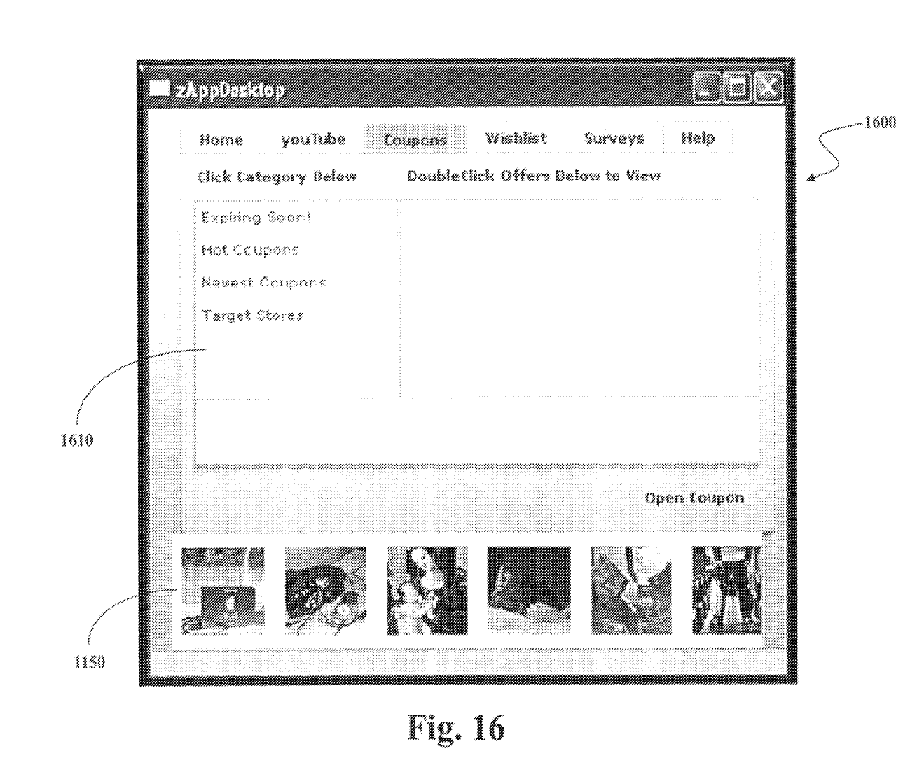

FIG. 16 is a window showing another exemplary benefit that is provided to the user in accordance with the present invention. In this case, the window 1600 displays coupon information or information regarding deals or discounts offered. In this case, the scrolling pane 1150 displays the deals or coupons targeted specifically to the user based on his or her recent browsing activity. These coupons and deals are identified by scanning the RSS feeds from various sources and identifying relevant deals or coupons based on the user's recent browsing activity. Field 1610 displays the coupons or deals by categories such as “Expiring Soon!” “Hot Coupons,” “Newest Coupons,” and “Specific Stores.”

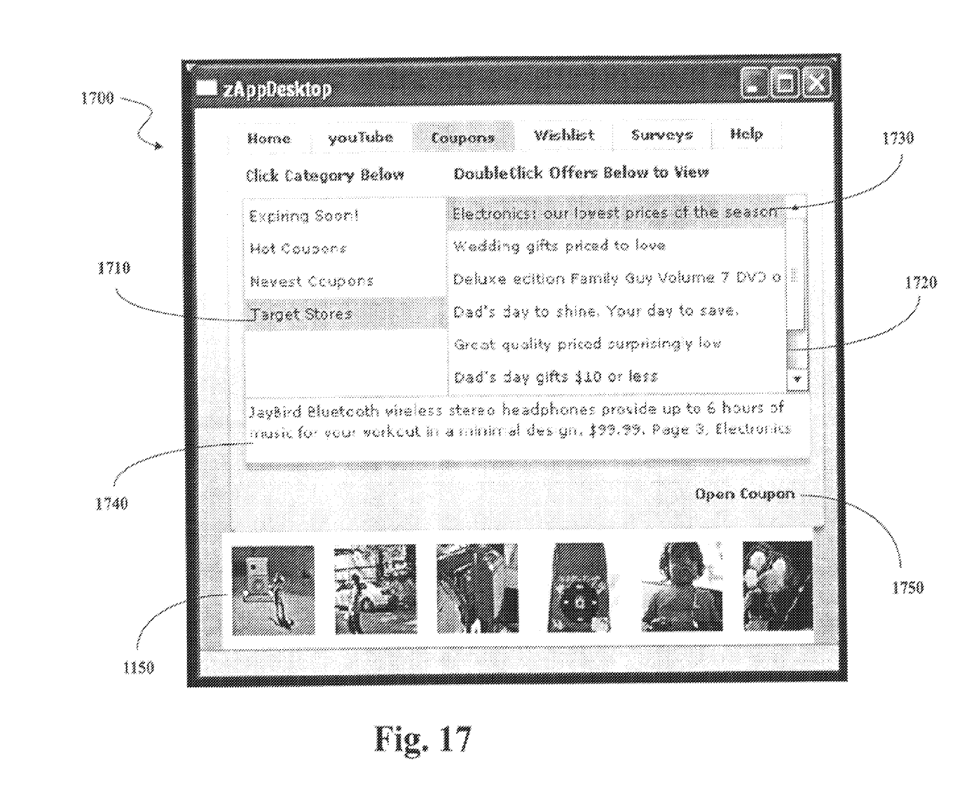

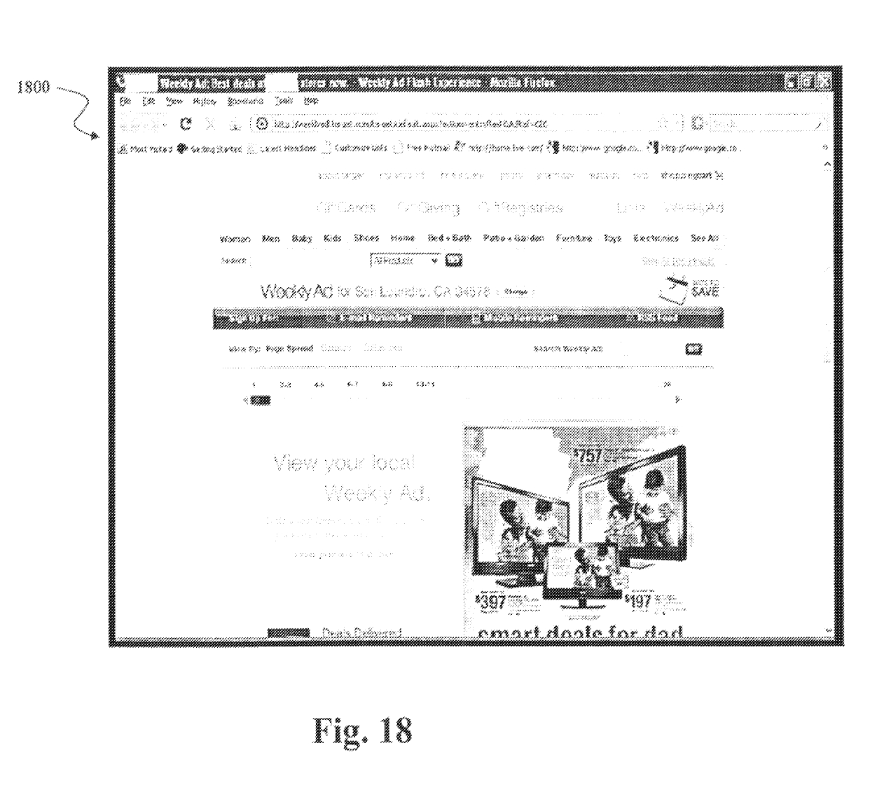

FIG. 17 shows the window of FIG. 16 when one of the categories in field 1610 is highlighted in accordance with an aspect of the invention. For example, by highlighting category 1710, window 1720 displays the deals and coupons offered by any given Specified Stores. When a user selects one of the offers in window 1720, such as offer 1730 then a summary of that deal or offer is provided in field 1740. Additionally, the user may connect to the website to view the full content of the offer or deal by clicking on the “Open Coupon” icon 1750. FIG. 18 shows the window 1800 that is opened when the user clicks on the “Open Coupon” icon 1750.

### Data Insertion Module

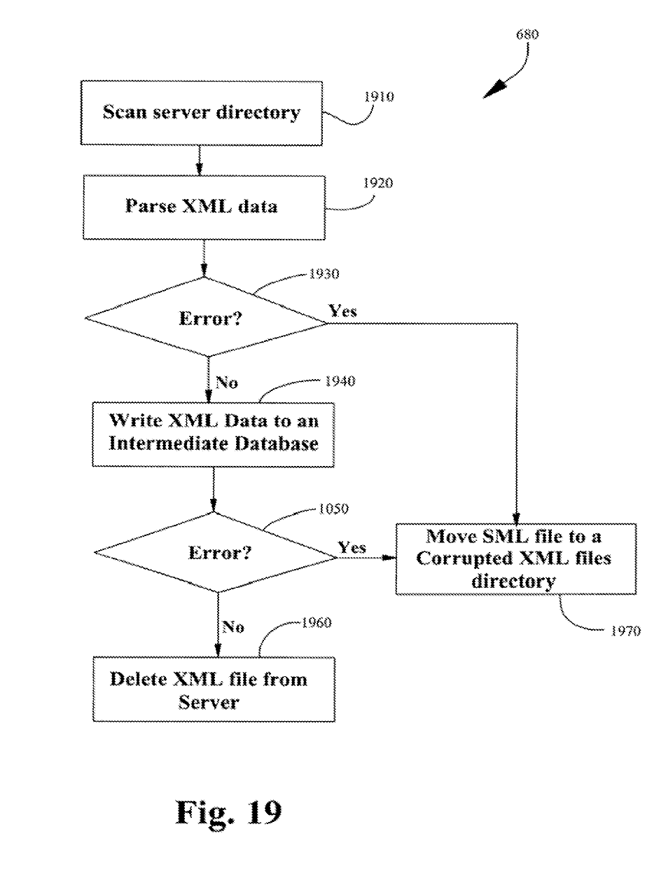

FIG. 19 is an illustrative flowchart showing the steps performed to retrieve and store the XML files received from the client device in accordance with an embodiment of the invention. On the server 120, there is a Java-based module that is implemented as a Tomcat “Servlet” created with the NetBeans integrated development environment. This servlet runs continuously on the server listening for connection requests made by the communication service 255. The servlet knows what port to look at by referring to its own configuration file called Server Config File 690. Any computer language (C, C++, C#, etc.) or scripting language (PHP, Perle, etc.) may be used to implement the steps illustrated in FIG. 19.

In step 1910, Data Insertion Module 680 scans the server directory (/usr/tomcat/xmloutdest/) every 6 seconds or any other predetermined time interval. If the module 680 finds XML files then the module parses the XML data (step 1920) using commonly known techniques. Preferably, module 680 reads the XML file using the SAXparser library. The XML file attributes, tags, and information are stored as an XmlPage object. The stored XmlPage object data is uniquely identified by the PageViewId which is a concatenation of the Respondent Identification, device identification and timestamp.

In step 1930, module 680 determines whether an error occurred during the parsing process. If an error occurs during the parsing process then the XML file is moved to a corrupted files directory 692 (step 1970) for further processing. If no error occurred during the parsing process then the extracted XML data is written to an Intermediate Database 640 for use by the data analysis module 685. The XML data is pushed into an XMLPage object which then writes the XML data to the Intermediate Database (step 1940). Once again, the system determines, in step 1950, whether an error occurred during the writing process. If an error occurred during the writing process, the XML file is moved to the corrupted files directory 692 for further processing. If the writing process is successfully completed then, in step 1960, the module 680 deletes the XML file from the XML Out directory 695.

### Data Analysis Module

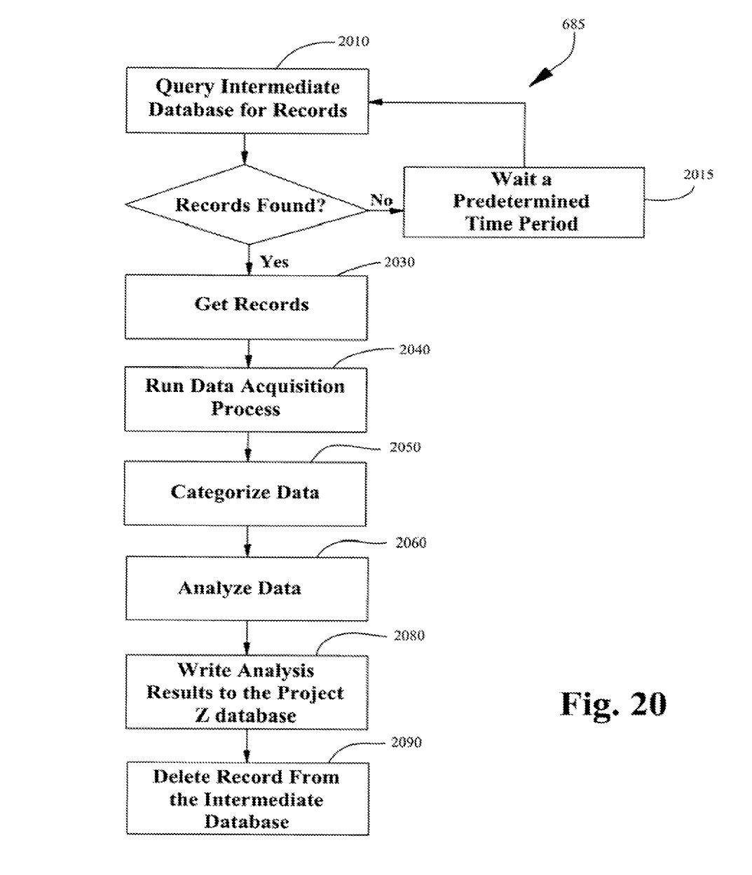

FIG. 20 depicts a flowchart illustrating the analysis steps performed by a server in accordance with the present invention. The XML data extracted by the insertion module 680 is then further analyzed by the data analysis module 685. Every 6 seconds or any predetermined time interval, in step 2010, the module 685 queries the Intermediate Database 640 for records. If there are no records in the Intermediate Database 640 then the module waits for a predetermined time intervals 2015 and queries again as shown in Step 2020 when the query results in a No answer. If the module 685 does find XML files in the Intermediate Database 640 then, in step 2030, it retrieves those records and further puts the records in order by the time stamp of the XML file creation. The Data Acquisition step 2040, Categorization step 2050 and Analysis step 2060 are performed on each XML record found and in the order defined by the query results in step 2030.

During the Data Acquisition Process, at step 2040, all data associated with the record is pulled into a PageData object. Next, during the Categorization process in step 2050, the server may render the website http://directory.google.com/, for example, and provides the base URL as a search parameter. This is done using the Java HttpURLConnection and URL libraries. The resulting categories are parsed using regular expression pattern matching to identify the top three levels of categorization. Next, in step 2060, the resulting PageData object is further analyzed by, for example, conducting a website/webpage analysis, keyword analysis and website visit analysis. The results of the data analysis are then written into the Z database 630 in step 2080. The record is then deleted from the Intermediate Database 640 in step 2090.

Although, the invention is described in terms of the three components described above, other components are also contemplated. For example, a module measuring user activity related to running other desktop application such as word processing, e-mail clients, online gaming, etc. is contemplated and would work in conjunction with the toolbar, Communication Service and AIR application to collect such data. Another module may collect data using a well-known technique for sniffing communication data-streams through the use of proxy software which is then transmitted and processed by the system 100.

The present principles are described in terms of a browser installed toolbar, but, according to present principles, may advantageously be applied to browser extensions, add-on components, or other software with similar capabilities.

Furthermore, the present principles can take the form of a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The embodiments described here are relevant to communication devices, computers, communications networks, web browsers, or any other system or device used for browsing informational resources such as web pages, documents, or the like.

We claim:

1. A system for collecting consumer browsing on-line behavior and survey data comprising:
a) a browser toolbar application located within a consumer's computing device, and interactively graphically displayed on said computing device, for collecting and recording consumer browsing activity information;
b) a communication service for transmitting said consumer browsing activity information to a server, wherein said server performs aggregation and analysis on said browsing activity information; and
c) a multi-platform communication application to render browsing activity information relevant content to consumers based on said toolbar application collected and recorded browsing activity and said performed aggregation and analysis.

2. The system for collecting consumer browsing on-line behavior and survey data, according to claim 1, wherein said computing device is a desktop computer, hand-held computer, wireless device, Internet enabled telephone, cell phone, smart phone or television.

3. The system for collecting consumer browsing on-line behavior and survey data, according to claim 1, wherein said system further includes a local proxy service for detecting and gathering a browsing consumer respondent's browsing activity information.

4. The system for collecting consumer browsing on-line behavior and survey data, according to claim 1, wherein said communication service for transmitting said consumer browsing activity information to a server, further includes communicating said browsing activity information in the form of XML data.

5. The system for collecting consumer browsing on-line behavior and survey data, according to claim 4, further including a data insertion module wherein said data insertion module accepts said information in the form of XML data and stores said data in a database.

6. The system for collecting consumer browsing on-line behavior and survey data, according to claim 5, further including a data analysis module wherein said a data analysis module performs analysis of the database data and writes the results to said database or a second database, for the purpose of generating reports based upon said data.

7. The system for collecting consumer browsing on-line behavior and survey data, according to claim 1, wherein said multi-platform communication application provides a communication link between said consumer and said server, allows said consumer to view, manage and update account information, provides said consumer with survey notifications, and allows said consumer to provide feedback on content viewed.

8. The system for collecting consumer browsing on-line behavior and survey data, according to claim 2, wherein said browser toolbar application is an add-on or extension application installed on said computing device and associates said consumer browsing activity information with said consumer and said computing device.

9. The system for collecting consumer browsing on-line behavior and survey data, according to claim 8, wherein said browser toolbar application installed on a consumers computing device allows said associated consumer the ability to participate in survey research and polling.

10. The system for collecting consumer browsing on-line behavior and survey data, according to claim 1, wherein said browser toolbar application for collecting and recording consumer browsing activity information, further gathers and uses multiple types of information and data sources including queries to the consumer, survey results, polling results and data regarding usage of other computer program desktop applications as well as browsing behavior to improve the accuracy of said collected and recorded consumer browsing activity information.

11. The system for collecting consumer browsing on-line behavior and survey data, according to claim 1, wherein said a communication service for transmitting said consumer browsing activity information to a server further includes a server capable of categorizing and analyzing browser activity information communicated to said server via said communication service.

12. The system for collecting consumer browsing on-line behavior and survey data, according to claim 11, wherein said server capable of categorizing and analyzing browser activity information communicated to said server via said communication service, further categorizes web pages based upon the intrinsic titles of said web pages.

13. A method of collecting consumer browsing on-line behavior and survey data, comprising the steps of:
a) providing a browser toolbar application installed on a consumer's computing device, and interactively graphically displayed on said computing device, for collecting and recording consumer browsing activity information;
b) providing a communication service for transmitting said consumer browsing activity information to a server, wherein said server performs aggregation and analysis on said browsing activity information; and
c) providing a multi-platform communication application to render browsing activity information relevant content to consumers based on said toolbar application collected and recorded browsing activity and said performed aggregation and analysis.

14. The method for collecting consumer browsing on-line behavior and survey data, according to claim 13, wherein said step of providing a toolbar application installed on a consumer's computing device includes installing said toolbar application on a desktop computer, hand-held computer, wireless device, Internet enabled telephone, cell phone, smart phone or television.

15. The method for collecting consumer browsing on-line behavior and survey data, according to claim 13, wherein said method further includes the step of providing a local proxy service for detecting and gathering a browsing consumer respondent's browsing activity information.

16. The method for collecting consumer browsing on-line behavior and survey data, according to claim 13, wherein said step of providing a communication service for transmitting said consumer browsing activity information to a server, includes providing a communication service that communicates said browsing activity information in the form of XML data.

17. The method for collecting consumer browsing on-line behavior and survey data, according to claim 16, wherein said step of providing a communication service that communicates said browsing activity information in the form of XML data, further includes providing a data insertion module wherein said data insertion module accepts said information in the form of XML data and stores said data in a database.

18. The method for collecting consumer browsing on-line behavior and survey data, according to claim 17, wherein said step of providing a data insertion module further includes the step of providing a data analysis module wherein said a data analysis module performs analysis of the database data and writes the results to said database or a second database, for the purpose of generating reports based upon said data.

19. The method for collecting consumer browsing on-line behavior and survey data, according to claim 13, wherein said step of providing a multi-platform communication application further includes the step of providing a multi-platform communication application wherein said multi-platform communication application provides a communication link between said consumer and said server, allows said consumer to view, manage and update account information, provides said consumer with survey notifications, and allows said consumer to provide feedback on content viewed.

20. The method for collecting consumer browsing on-line behavior and survey data, according to claim 14, wherein said step of providing a browser toolbar application further includes the step of providing a browser toolbar application wherein said browser toolbar application is an add-on or extension application installed on said computing device and associates said consumer browsing activity information with said consumer and said computing device.
